(19) United States
(12) Patent Application Publication
(10) Pub. No.: US 2010/0208660 A1
(43) Pub. Date: Aug. 19, 2010

(54) METHOD FOR DISTRIBUTED DRX OPERATION FOR EASE OF SCHEDULING AND EFFECTIVE POWER SAVING

(75) Inventor: Baowei JI, Plano, TX (US)

Correspondence Address: Jefferson IP Law, LLP, 1130 Connecticut Ave., NW, Suite 420, Washington, DC, 20036, US

(73) Assignee: Samsung Electronics Co., Ltd., Suwon-si (KR)

(21) Appl. No.: 12/683,018

(22) Filed: Jan. 6, 2010

Related U.S. Application Data
(60) Provisional application No. 61/208,086, filed on Feb. 19, 2009.

(51) Int. Cl. H04W 40/00

(52) U.S. Cl. 370/328

(57) ABSTRACT

A method for improving performance of a discontinuous reception (DRX) mode is provided. The method includes assigning a plurality of DRX Start Offsets to a plurality of mobile stations served by a base station. By assigning a plurality of DRX Start Offsets to mobile stations, the mobile stations will not wake up at the same time, thus preventing excessive signaling overhead as well as improving scheduling and improving the power saved by a mobile station while executing DRX.

### CROSS-REFERENCE TO RELATED APPLICATIONS

This application claims the benefit under 35 U.S.C. §119(e) of U.S. Provisional Application No. 61/208,086 filed in the U.S. Patent and Trademark Office on Feb. 19, 2009, the entire disclosure of which is hereby incorporated by reference.

### BACKGROUND OF THE INVENTION

1. Field of the Invention

The present invention relates to Discontinuous Reception (DRX) operation in a wireless communication system. More particularly, the present invention relates to a method for improving DRX operations in a wireless communication system.

2. Description of the Related Art

A Universal Mobile Telecommunications System (UMTS) is a 3^{rd} Generation (3G) mobile telecommunication technology. The UMTS evolved from the Global System for Mobile communications (GSM) and General Packet Radio Services (GPRS) and uses Wideband Code Division Multiple Access (WCDMA).

The 3^{rd} Generation Partnership Project (3GPP), which is responsible for the standardization of UMTS, is working to significantly expand the performance of UMTS with the Long Term Evolution (LTE) standard. LTE is a 3GPP standard that provides for a downlink speed of up to 100 Mbps and is expected to be commercially launched in 2010. Furthermore, other advanced technologies are also being expanded and improved in order to provide greater downlink speeds. For example, the Institute of Electrical and Electronics Engineers (IEEE) 802.16m standard as well as the Worldwide Interoperability for Microwave Access (WiMAX) forum are advancing technologies to provide downlink speeds in excess of 100 Mbps.

In the LTE system, as in the IEEE 802.16m standard and WiMax forum, a Discontinuous Reception (DRX) mode is supported to prolong the mobile station's or User Equipment's (UE's) battery life. In DRX mode, the UE switches on a receiver to listen to a downlink control channel for an active period and then switches off the receiver for an inactive period following the active period to save the battery power. The switch-on time arrives periodically. In order to further improve the power saving effect, either of a short DRX cycle length or a long DRX cycle length may be used for different types of services. In this case, the UE can transition between the two DRX cycle lengths when a transition event is fulfilled.

In implementation, several UEs provided service by an evolved Node B, which is a base station in the LTE system, may simultaneously execute a DRX mode. In this case, the UEs may not be able to fully exploit the power savings available in the DRX mode due to an abundance of traffic to be provided by the eNB. Accordingly, there is a need to provide an improved method for implementing a DRX mode.

### SUMMARY OF THE INVENTION

An aspect of the present invention is to address at least the above-mentioned problems and/or disadvantages and to provide at least the advantages described below. Accordingly, an aspect of the present the present invention is to provide an improved method for Discontinuous Reception (DRX) in a mobile communication system.

Another aspect of the present invention is to provide a method for distributing a DRX operation among mobile stations served by a base station so that the mobile stations do not wake up at the same time.

Yet another aspect of the present invention is to provide a method for assigning different DRX Start Offsets for mobile stations served by a base station so that the mobile stations do not wake up at the same time.

Still another aspect of the present invention is to provide a method for dividing the mobile stations served by a base station into groups and providing a different DRX Start Offset for each group.

Another aspect of the present invention is to provide a method for transmitting a message to mobile stations in a group that includes information regarding whether data is to be transmitted to each mobile station.

Yet another aspect of the present invention is to provide a method in which a mobile station determines if a message regarding whether data is to transmitted has been sent.

Still another aspect of the present invention is to provide a method for broadcasting a list of DRX Start Offsets and assigning a mobile station to a DRX Start Offset.

Another aspect of the present invention is to provide a method for broadcasting a list of DRX Start Offsets and transmitting a message for use by a mobile station to determine which DRX Start Offset it is to use.

According to an aspect of the present invention, a method for a Discontinuous Reception (DRX) control method of a base station in a wireless communication system is provided. The method includes executing a DRX mode, and assigning a plurality of DRX Start Offsets to a plurality of mobile stations served by the base station.

According to an aspect of the present invention, a method for a Discontinuous Reception (DRX) control method of a mobile station in a wireless communication system is provided. The method includes entering a DRX mode, determining if a message indicating activity for the mobile station is received, if the message indicating activity for the mobile station is received, determining if the message indicates an activity, if the message does not indicate an activity, transitioning to a sleep mode, and, if the message indicates an activity, receiving data transmission.

According to an aspect of the present invention, a method for a Discontinuous Reception (DRX) control method of a mobile station in a wireless communication system is provided. The method includes receiving a Cell-Radio Network Temporary Identifier (C-RNTI) upon entering a network, entering a DRX mode, receiving a list of DRX Start Offsets, and determining, using the C-RNTI, a DRX Start Offset from the list of DRX Start Offsets for use in the DRX mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIGS. 1A and 1B are timing diagrams illustrating transition timings between long and short Discontinuous Reception (DRX) cycles for explaining a DRX control method according to an exemplary embodiment of the present invention;

FIG. 2 is a timing diagram illustrating various timer operations for explaining a DRX control method according to an exemplary embodiment of the present invention;

FIG. 3 illustrates a Media Access Control (MAC) control element sub-header and MAC Protocol Data Unit (PDU) for explaining a DRX control method according to an exemplary embodiment of the present invention;

FIG. 4 illustrates operation of an Institute of Electrical and Electronics Engineers (IEEE) 802.16(e) Power Saving Class (PSC) Type 1 Sleep Mode for explaining a DRX control method according to an exemplary embodiment of the present invention;

FIG. 5 illustrates operation of an IEEE 802.16(e) PSC Type 1 Sleep Mode wherein Traffic Triggered Wakening Flag (TTWF)=0 for explaining a DRX control method according to an exemplary embodiment of the present invention;

FIG. 6 illustrates signaling operations between a User Equipment (UE) and a evolved Node B (eNB) during a UE initiated awakening for explaining a DRX control method according to an exemplary embodiment of the present invention;

FIG. 7 illustrates signaling operations between a UE and an eNB during an eNB initiated awakening for explaining a DRX control method according to an exemplary embodiment of the present invention;

FIG. 8 is a timing diagram illustrating DRX Start Offsets for different DRX Groups according to an exemplary embodiment of the present invention; and

FIG. 9 illustrates an identifier message used to assign a UE to a DRX group according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, exemplary methods for improving Discontinuous Reception (DRX) operations are provided. The following description may make use of terminology that is specific to a certain mobile communication technology. However, this is not to be construed as limiting the application of the invention to that specific technology. For example, although terms such as User Equipment (UE) and evolved Node B (eNB), which are terms associated with the Long Term Evolution (LTE) communication standard, may be used in the following description, it is to be understood that these are merely specific terms for the generic concepts of a mobile station and a base station. That is, the present invention may be applied not only to systems employing the LTE standard, but equally to any communication system using a DRX operation, such as the Institute of Electrical and Electronics Engineers (IEEE) 802.16m standard as well as the Worldwide Interoperability for Microwave Access (WiMAX) forum technologies.

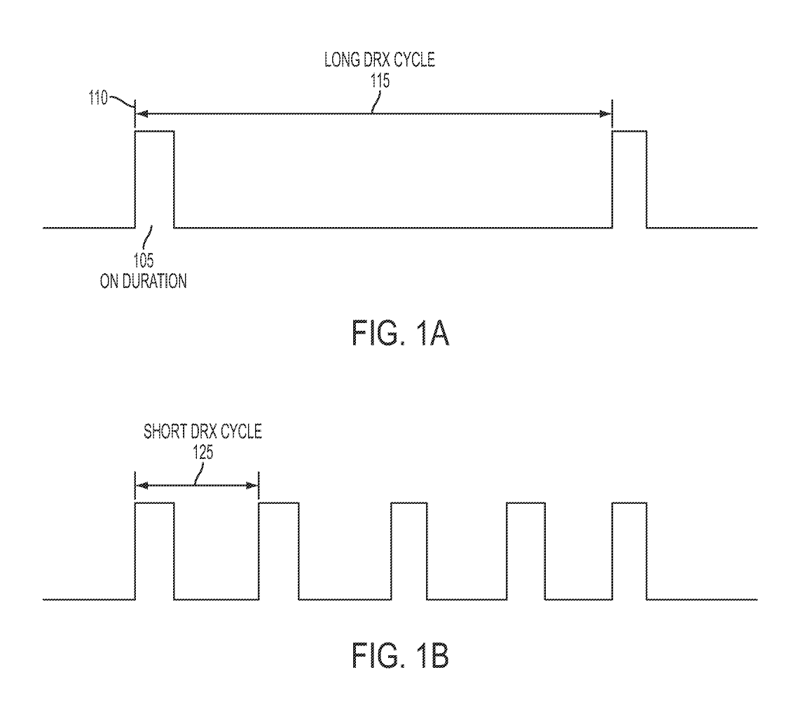

FIGS. 1A and 1B are timing diagrams illustrating transition timings between long and short DRX cycles for explaining a DRX control method according to an exemplary embodiment of the present invention.

Referring to FIGS. 1A and 1B, reference numeral 105 denotes an “on duration” during which a UE wakes up for monitoring a Physical Downlink Control Channel (PDCCH). The PDCCH is a downlink control channel for transmitting downlink and uplink resource assignments and other control information. If no scheduling is assigned during the on duration, the UE transitions to a sleep state to save battery power. That is, the UE transitions to an “off duration” or an “off” state. However, this is not to be interpreted that the UE is powered off.

In FIG. 1A, reference numeral 115 denotes a “long DRX cycle” which is relatively long in length as compared to a “short DRX cycle” 125 illustrated in FIG. 1B. The long DRX cycle 115 is composed of the on duration period starting at the beginning 110 of the on duration period and a sleep period following the on duration period. Notably, the on duration 105 of the DRX cycle need not be fixed. Rather, the length of the on duration 105 may vary depending on various system parameters.

Reference numeral 125 denotes a “short DRX cycle” which is relatively short in length as compared to the “long DRX cycle”. If a predefined transition event (e.g., scheduling assignment) occurs while operating with the long DRX cycle 115, the UE switches from the long DRX cycle 115 to the short DRX cycle 125. While operating with the short DRX cycle 125, the UE wakes up at the beginning (on duration start time 110) of every short DRX cycle and stays on for the entire on duration period.

The DRX mode (a.k.a. sleep mode) is an important feature for saving power in advanced handset devices. At the beginning of each long DRX cycle 115 or short DRX cycle 125, a UE starts an On Duration Timer (not shown) and stays powered on for an on duration 105. If there is no activity during the on duration 105, as shown in FIGS. 1A and 1B, the UE switches off upon the expiration of the On Duration Timer.

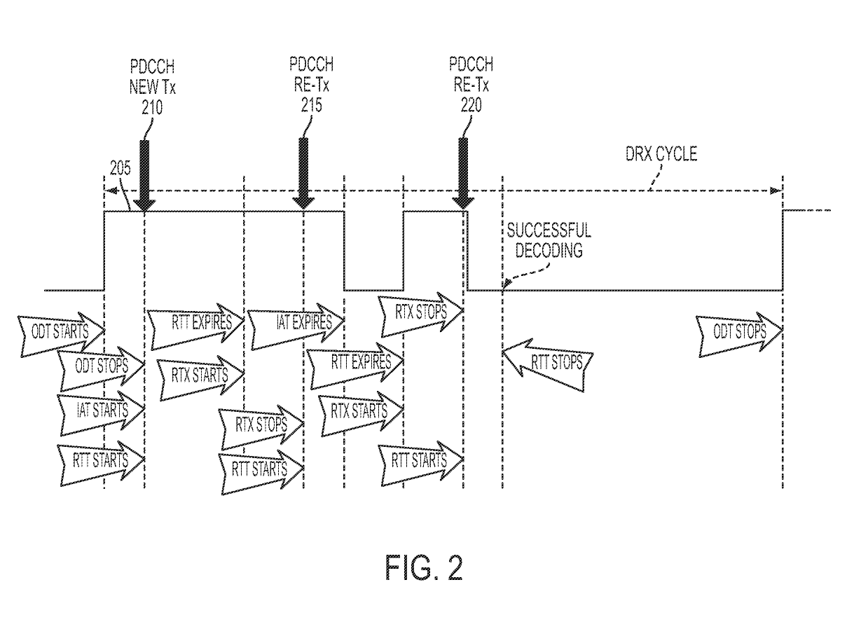

FIG. 2 is a timing diagram illustrating various timer operations for explaining a DRX control method according to an exemplary embodiment of the present invention.

Referring to FIG. 2, the following parameters are used for handling more complex situations in DRX:
DRX Inactivity Timer (IAT): This parameter specifies the number of consecutive PDCCH-subframe(s) that pass after successfully decoding a PDCCH indicating an initial UpLink (UL) or DownLink (DL) user data transmission for this UE. The IAT is started or restarted only when it is indicated by a PDCCH-subframe that there is a “new” data transmission. In other words, the IAT could be interpreted as a maximum separation between the scheduling of two “new” data transmissions at the eNB side.
HARQ RTT Timer (RTT): This parameter specifies the minimum number of subframe(s) before a DL Hybrid Automatic Repeat reQuest (HARQ) retransmission is expected by the UE, which means the UE does not have to monitor for any retransmission for that HARQ process when the RTT timer of that HARQ process is running. In other words, the UE may have an opportunity for sleep when an RTT timer is running if the situation otherwise allows.
DRX Retransmission Timer (RTX): This parameter specifies the maximum number of consecutive PDCCH-subframe(s) expected before a DL HARQ retransmission for the UE. When the RTX is running, the UE has to monitor each PDCCH-subframe to see whether there is HARQ retransmission.
DRX Short Cycle Timer (SCT): This parameter specifies the number of consecutive subframe(s) the UE shall use the short DRX cycle after the IAT has expired. When the SCT expires, the UE shall switch from a short DRX cycle to a long DRX cycle.
On Duration Timer (ODT): Specifies the minimum number of consecutive PDCCH-subframe(s) the UE has to monitor at the beginning of a DRX Cycle before it could switch to the “Off duration” (also see FIG. 1).

As illustrated in FIG. 2, when a new transmission 210 is detected during an on duration 205, defined by the starting of an ODT, an IAT and an RTT are started and the ODT is stopped. In this example, the IAT expires after re-transmission of the PDCCH 215 but before the data was successfully decoded. More specifically, upon detection of the new transmission in the PDCCH subframe 210, the IAT is started to track a maximum time between two transmissions from the eNB and the RTT is started to track the minimum time before DL HARQ retransmission is expected. Upon expiration of the RTT, an RTX starts to track a maximum time for DL HARQ re-transmission, which is monitored by the UE. At the expiration of the IAT, the UE may exploit the opportunity for sleep when only an RTT timer is running. However, the expiration of the RTT timer causes the UE to switch back to “On” to look for a retransmission 220. Upon receipt of the retransmission 220, the RTX is stopped and the RTT is started until the data received in the retransmission 220 is successfully decoded, at which time the RTT is also stopped. Upon successful receipt of the data, the UE stays “Off” until the start of the next long or short DRX cycle, dependent on whether the short or long DRX cycle is implemented.

Therefore, a UE has to stay “On” as long as any of the ODT, IAT, RTX and/or a Contention Resolution Timer is running. When any of these timers is running, the UE has to monitor each PDCCH-subframe because there could be data transmission or retransmission at each subframe of the on duration. This dramatically undermines the effectiveness of power saving in DRX, especially when one or multiple of these timers have large values. Furthermore, it is difficult to use a small value for these timers because of implementation and scheduling issues, especially for the eNB.

One process introduced in an attempt to address this issue used a DRX Command Media Access Control (MAC) control element, called a “Go-Sleep” command. Upon receiving this Go-Sleep command, the UE stops the ODT and the IAT.

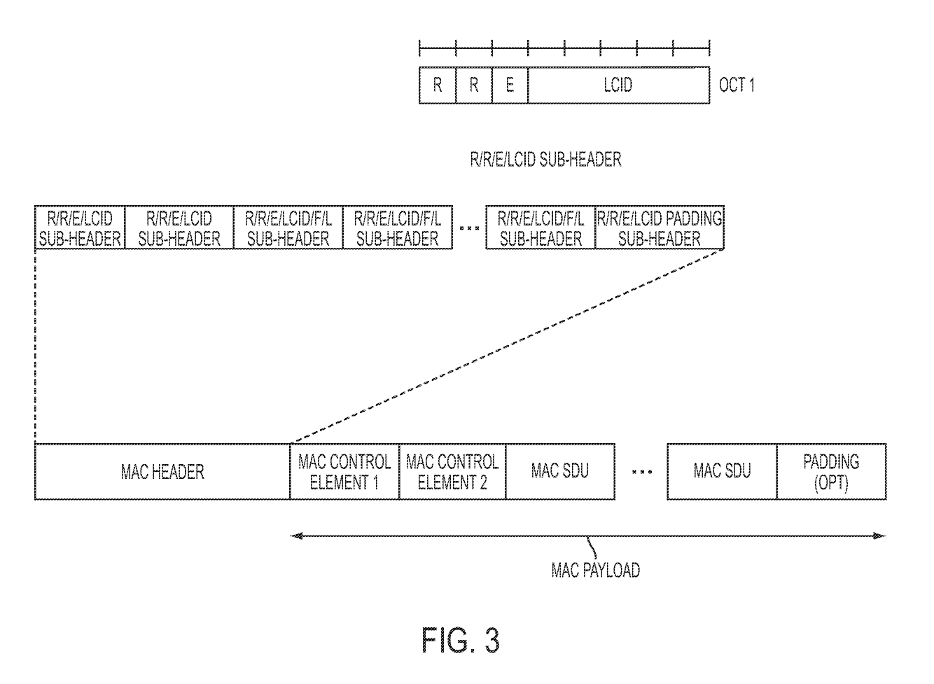

FIG. 3 illustrates a MAC control element sub-header and MAC Protocol Data Unit (PDU) for explaining a DRX control method according to an exemplary embodiment of the present invention.

Referring to FIG. 3, and as specified in the 3^{rd} Generation Partnership Project (3GPP) Technical Specification (TS) 36.321 V8.4.0 (2008-12), TS Group Radio Access Network; Evolved Universal Terrestrial Radio Access (E-UTRA); Medium Access Control (MAC) protocol specification (Release 8), a DRX command MAC control element is a pure control element using a specific logic connection ID (LCID) of 11110. In other words, as shown in FIG. 3, the Go-Sleep command is one byte by itself if there is no other control signaling or data transmission. However, inclusion of the Go-Sleep command should be indicated in the PDCCH so that the UE knows where to locate and decode the Go-Sleep command. This is because each Go-Sleep command is applicable for a single UE.

When DRX is configured, the UE shall start its ODT for each subframe using either Equation (1) or Equation (2), depending on which DRX cycle is used. For short cycle DRX:

[(SFN*10)+subframe number] modulo (Short DRX Cycle)=(DRX Start Offset) modulo (Short DRX Cycle) Eq. (1)

For long cycle DRX:

[(SFN*10)+subframe number] modulo (Long DRX Cycle)=DRX Start Offset Eq. (2)

In Equations (1) and (2), SFN (System Frame Number) denotes a counter and corresponds to a radio frame. The SFN is included in system information that is broadcast within the service coverage area of the eNB. That is, as specified in 3GPP TS 36.331 V8.4.0 (2008-12), TS Group Radio Access Network; Evolved Universal Terrestrial Radio Access (E-UTRA); Radio Resource Control (RRC) protocol specification (Release 8), the RRC specifies the MAC main configuration using the MAC-MainConfiguration Information Element (IE) that contains all the DRX parameters. In other words, each eNB utilizes one set of DRX parameters for all the UEs in its service coverage area. Therefore, all the UEs would wake up at the same instance at the beginning of next DRX cycle, and wait for data activity for the entire on duration. This results in the following drawbacks.

First, a large number of UEs are typically operating in DRX. If the eNB has buffered data for several of the UEs, the eNB has to schedule and transmit at least one “new” data to each of those UEs within the “ON” duration. Otherwise, the UEs will switch to an “Off” state if there is no activity before expiration of the ODT. This results in a strict scheduling requirement when the eNB has buffered data for several UEs.

Second, the eNB should send a Go-Sleep command to those UEs without any data buffered at the eNB. Otherwise, those UEs cannot switch to an “Off” state until the expiration of their ODT. Moreover, the Go-Sleep commands should be sent to the UEs as early as possible in order to maximize the power saving for these UEs. Furthermore, and to make the situation worse, the eNB has to send a Go-Sleep command to each UE together with the mapping information in the PDCCH. These limitations present a tremendous burden given that all the UEs wake up at the same time and a Go-Sleep command is only for a specific UE. In actuality, the above limitations may make it impossible for the eNB to send Go-Sleep commands to many UEs.

In the Institute of Electrical and Electronics Engineers (IEEE) 802.16e standard, as well as in the Worldwide Interoperability for Microwave Access (WiMAX) standard, there are three power saving schemes. Power Saving Class (PSC) Type I is used for Best Effort (BE) connections and Non-Real-Time Variable Rate (NRT-VR) type applications, PSC Type II is used for connections of Unsolicited Grant Service (UGS) and Real-Time Variable Rate (RT-VR) type applications, and PSC Type III is used for multicast connections as well as for management operations.

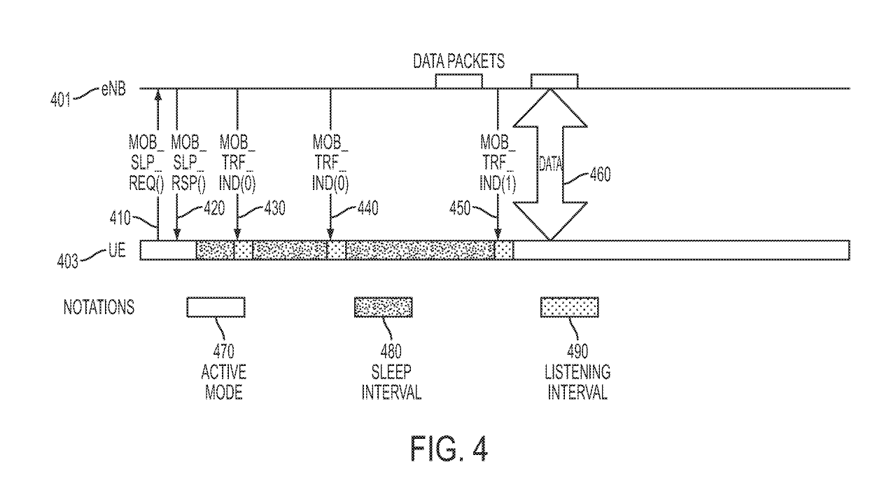

FIG. 4 illustrates operation of an 802.16(e) PSC Type 1 Sleep Mode for explaining a DRX control method according to an exemplary embodiment of the present invention.

Referring to FIG. 4, in PSC Type I Sleep Mode, sleep windows (a.k.a., sleep intervals) 410 of varying duration are interleaved with listening windows (a.k.a., listening intervals) 420 of fixed duration. More specifically, a UE 403 transmits a MOBile_SLeeP_REQuest (MOB_SLP_REQ) to an eNB 401 in step 410. As conditions permit, the eNB 401 transmits a MOBile_SLeeP_ReSPonse (MOB_SLP_RSP) message to the UE 403 permitting the UE to enter a sleep mode. At the end of a first sleep mode period, the UE 403 awakes for reception of a MOBile_TRaFfic_INDication (MOB_TRF_IND) message from the eNB 401. That is, the eNB 401 provides indication to the UE 403 regarding DL traffic. If there is no DL traffic, the eNB 401 transmits a MOB_TRF_IND (0) in step 430 at which point the UE 403 returns to a sleep interval. The sleep interval doubles in successive DRX cycles until the sleep interval reaches an upper limit. That is, if a first sleep interval has a duration X, a second sleep interval after the first MOB_TRF_IND (0) message 430 has a duration of 2×, and a third sleep interval after a second MOB_TRF_IND (0) message 440 has a duration of 4×. If Traffic_Triggered_Wakening_Flag (TTWF) is ‘1’ (i.e., TTWF=1), the UE 403 returns to normal operation (i.e., active mode) given the message MOB_TRF_IND (1), which indicates there is DL data traffic for transmission in step 460.

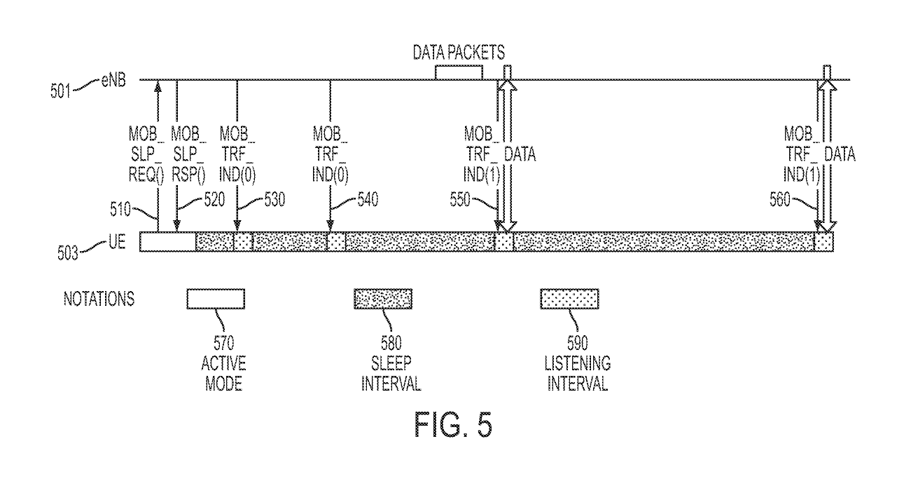

FIG. 5 illustrates operation of an 802.16(e) Type 1 Sleep Mode wherein TTWF=0 for explaining a DRX control method according to an exemplary embodiment of the present invention.

Referring to FIG. 5, the messaging between an eNB 501 and a UE 503 is substantially the same as illustrated in FIG. 4 and therefore a detailed explanation of all steps will not be provided for conciseness. That is, modes 570, 580 and 590 are substantially the same as modes 470, 480 and 490 and steps 510, 520, 530, and 540 are substantially the same as steps 410, 420, 430 and 440 of FIG. 4. In the example of FIG. 5, since TTWF=0, the PSC is not deactivated if traffic appears. In other words, data traffic is allowed in the sleep mode if TTWF=0. However, the data traffic is allowed only in listening intervals 590 such that data is only transmitted at steps 550 and 560 corresponding to successive listening intervals having a fixed, short duration. The MS also automatically returns to normal operation whenever it has UL data ready for transmission.

In PSC Type II, all sleep windows are of the same size, and interleave with listening windows of fixed duration. Similar to PSC Type I, a UE exits Sleep Mode when it needs to or when it is instructed by an eNB. For PSC Type I and Type II, the defining of sleep and listening windows and the activating of Sleep Mode are done by transmitting MAC messages (e.g., UE initiated MOB_SLP_REQ or BR and UL Sleep Control, eNB initiated MOB_SLP_RSP or DL Sleep Control Extended Subheader)). The deactivation of Sleep Mode is done by the eNB sending a MOB_TRF_IND message with a positive indication when TTWF=1. Alternatively, a MAC RaNGing_REQuest (RNG_REQ) message can also be used to define, activate and deactivate Sleep Mode. In PSC Type III, signaling methods for definition and activation of a sleep window are the same as in PSC Type I and Type II. However, deactivation of Sleep Mode occurs automatically at the end of a sleep window (i.e., each sleep cycle lasts just one time period and one sleep window needs one definition/activation).

The power saving operations described above were designed in favor of packet latency, but not designed in favor of power saving performance in Sleep Mode. That is, the definition, activation, deactivation and reactivation of DRX are all signal-driven.

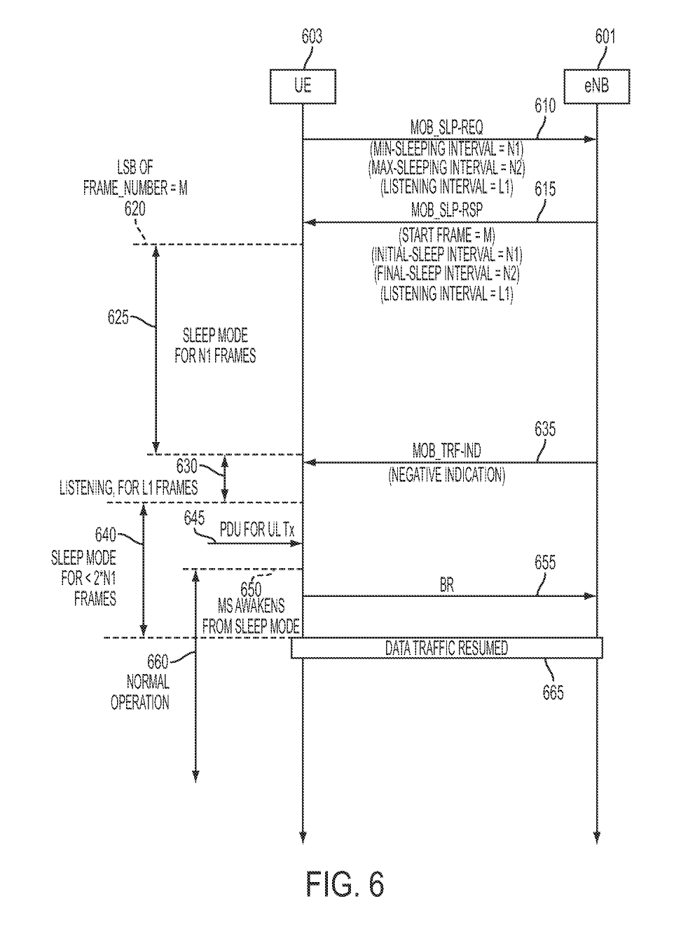

FIG. 6 illustrates signaling operations between a UE and an eNB during a UE initiated awakening for explaining a DRX control method according to an exemplary embodiment of the present invention.

Referring to FIG. 6, an eNB 601 receives a MOB_SLP_REQ message transmitted by a UE 603 in step 610. The MOB_SLP_REQ message includes sleep information such as a minimum sleeping interval N1, a maximum sleeping interval N2 and a listening interval L1. The variables N1, N2 and L1 are system dependent and vary according to system parameters. In response, the eNB 601 transmits a MOB_SLP_RSP message in step 615. The MOB_SLP_RSP message includes additional sleep information such as a start frame M, an initial sleep interval N1, a final sleep interval N2 and a listening interval L1. Upon receipt of the MOB_SLP_RSP message, the UE 603 determines a Least Significant Bit (LSB) of a frame associated with the start frame variable M in step 620 and enters a sleep mode for N1 frames in step 625. At the expiration of the N1 frames, the UE 603 awakens in step 630 for a listening interval that includes L1 number of frames. At that time, the eNB 601 transmits a MOB_TRF_IND message in step 635 that indicates there is no DL traffic for the UE 603. Accordingly, in step 640, the UE 603 returns to a sleep mode. However, the sleep mode duration in step 640 is now double that of the previous sleep mode duration in step 625. That is, the sleep mode duration of step 640 is 2×N1. During the second sleep mode, the UE 603 determines that Packet Data Units (PDUs) are ready for UL transmission in step 645. Accordingly, the UE 603 awakens from the sleep mode for transmission of the PDUs in step 650 and transmits a Bandwidth Request (BR) to the eNB 601 in step 655. Upon allocation of the requested bandwidth, the UE 603 resumes normal operation in step 660 including transmission of data traffic in step 665.

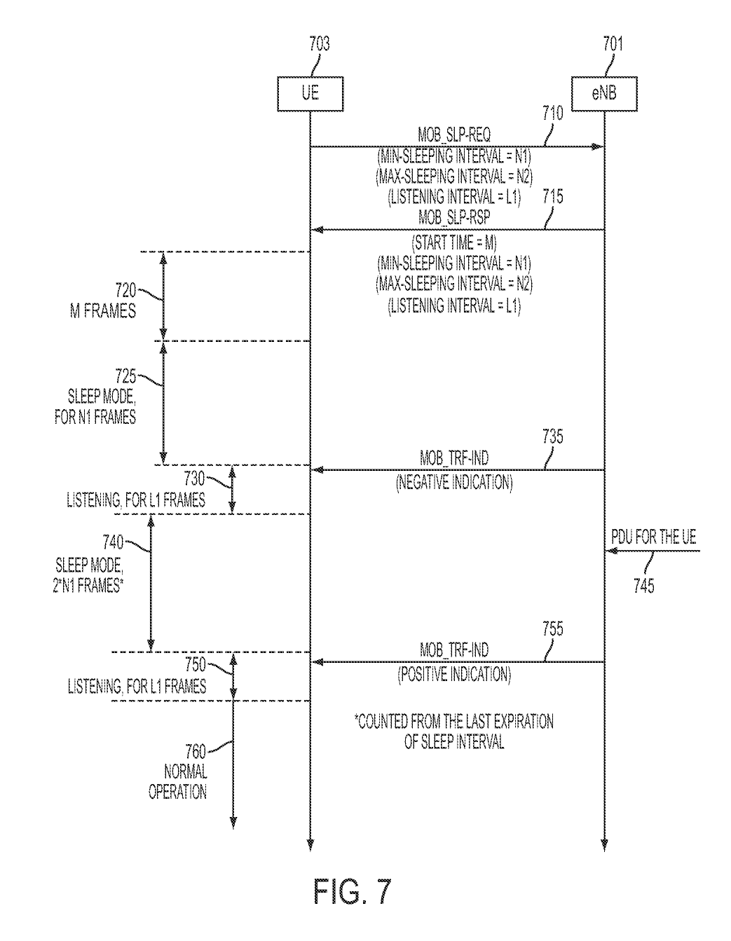

FIG. 7 illustrates signaling operations between a UE and an eNB during an eNB initiated awakening for explaining a DRX control method according to an exemplary embodiment of the present invention.

Referring to FIG. 7, an eNB 701 and a UE 703 exchange MOB_SLP_REQ and MOB_SLP_RSP messages in steps 710 and 715. This exchange of messages is substantially the same as that described with reference to steps 610 and 615 of FIG. 6 and therefore will not be described again for conciseness. In step 720, the UE 703 determines an appropriate frame in which to begin a sleep mode and in step 725 begins the sleep mode for N1 frames. In step 730, the UE 703 awakens during a listening interval including L1 frames and determines if there is traffic to receive from eNB 701. The eNB 701 transmits a MOB_TRF_IND message in step 735 indicating that there is no traffic so that in step 740, the UE 703 returns to sleep mode, this time for 2×N1 frames. In step 745, the eNB 701 receives a PDU destined for the UE 703. Accordingly, the eNB 701 awaits the next listening interval, which the UE 703 enters in step 750, and transmits a MOB_TRF_IND message indicating that traffic for the UE 703 does exist. In that case, the UE 703 performs normal operations in step 760 including receiving the PDU from the eNB 701.

As is illustrated by FIGS. 6 and 7, if the adapting of a power saving configuration to the changing of MS traffic patterns and activity levels requires a substantial amount of signaling, thus invoking a substantial amount of system overhead. This amount of signaling overhead requires resources that could be used for other purposes.

In the above description, the typical settings include TTWF=1. In that case, the UE must exit the sleep mode for transmission/reception of UL/DL data traffic. For light, bursty traffic, the UE may frequently alternate between active mode and sleep mode, which results in the exchange of an even greater number of MOB_SLP_REQ/RSP messages, i.e., additional signaling overhead.

Alternatively, if TTWF=0, the UE could receive data without leaving the sleep mode. However, the UE can only receive data during the listening interval such that remaining data has to be transmitted in following intervals. Moreover, the sleep interval continues to double even though there is positive traffic indication.

Exemplary embodiments of the present invention provide a method for DRX that avoids heavy signaling as well as frequent entry and exit of a sleep mode. Moreover, exemplary embodiments of the present invention do not suffer from the limitations as discussed above. That is, exemplary embodiments of the present invention address at least the following drawbacks:
An eNB may not be able to schedule and transfer data to all UEs in its service coverage area if it has buffered data for a large number of UEs, because all the UEs in DRX mode would awake at the same time and wait for data transmission in the “On Duration”. If there is no data transmission, a UE will switch to the “Off Duration” upon the expiration of the “On Duration Timer”.
On the other hand, the eNB may not be able to send a Go-Sleep command to each UE that has no data buffered at the eNB, because (i) those Go-Sleep commands should be sent to the UEs as early as possible in order to maximize the power saving for the UEs, and (ii) the eNB has to send a Go-Sleep command to each UE together with the mapping information in the PDCCH. In implementation, this limitation may make it impossible for the eNB to send Go-Sleep commands to all UEs.

In exemplary embodiments of the present invention, an eNB distributes a DRX operation such that all UEs do not wake up at the same time instant.

In a first exemplary embodiment of the present invention, an eNB can distribute the DRX operation by assigning various “DRX Start Offsets” to UEs served by the eNB. In this case, all of the served UEs will not awake at the same time. In an exemplary implementation, an eNB applies either of Equation (3) or Equation (4) to achieve a distributed DRX operation.

When DRX is configured according to an exemplary embodiment of the present invention, each UE served by the eNB shall start its ODT for each subframe as follows:

For short cycle DRX:

[(SFN*10)+subframe number] modulo (Short DRX Cycle)=(DRX Start Offset) modulo (Short DRX Cycle) Eq. (3)

For long cycle DRX:

[(SFN*10)+subframe number] modulo (Long DRX Cycle)=DRX Start Offset Eq. (4)

In an exemplary implementation of the present invention using Equation (3) and Equation (4), an eNB ensures that UEs served by the eNB have different DRX Start Offsets such that the all UEs served by the eNB do not wake up at the same time. For example, the eNB may unicast the offset parameters to a UE during the DRX negotiation.

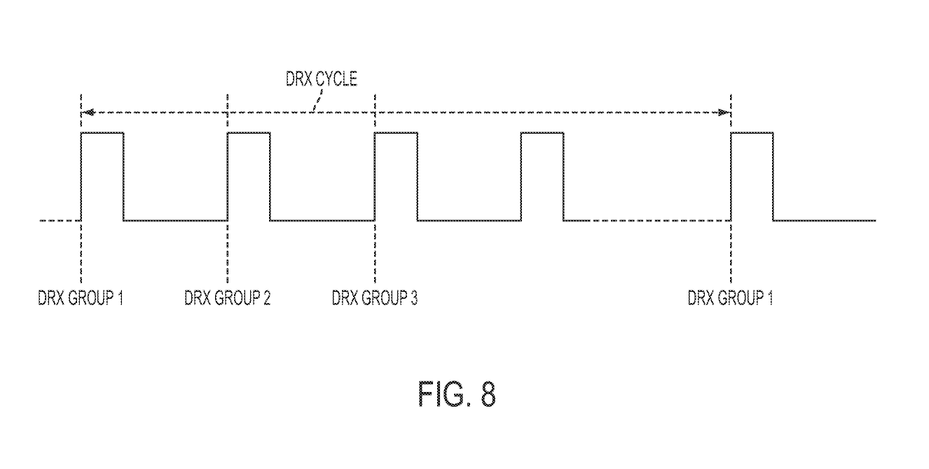

FIG. 8 is a timing diagram illustrating DRX Start Offsets for different DRX Groups according to an exemplary embodiment of the present invention.

Referring to FIG. 8, a single DRX Cycle 801 includes N number of DRX Start Offsets. That is, the UEs served by an eNB are divided into N number of groups wherein each group is assigned a different DRX Start Offset and each UE within the group uses the assigned DRX Start Offset. That is, each DRX group consists of a number of MSs that all use the same DRX Start Offset. Accordingly, all UEs served by the eNB do not awake at the same time.

The size of each DRX group is selected so that the eNB does not suffer from a scheduling limitation as discussed above. In an exemplary implementation, the UEs are grouped based on their application types such as VoIP or web browsing, or grouped based mobility, battery level and power protection requirements, or a certain service level agreement. Moreover, these DRX Start Offsets are arranged in such a way that the BS could process one DRX group after the other. For example, the DRX groups could be equally spaced as illustrated in FIG. 8. In an alternative embodiment, the DRX Start Offsets could be unequally spaced as determined by an eNB based on system requirements.

In yet another exemplary embodiment, an eNB may transmit an Activity-Indicator (AI) message to all UEs in one DRX group at the beginning of the “On Duration” of that DRX group. That is, as discussed above with reference to FIG. 8, the eNB may separate the UEs served by the eNB into various DRX groups. After the UEs are in different DRX groups and a DRX process may be executed, the eNB may transmit an AI message to all UEs in a DRX group at the beginning of the on duration for that DRX group. By transmitting an AI message to the UEs, the eNB can avoid sending a Go-Sleep command to each MS as discussed above. The AI message may be sent as a broadcast/multicast message, similar to a paging message using a Paging-Radio Network Temporary Identifier (P-RNTI). Hence, an AI-RNTI message could be defined for this purpose. Within this AI message, there are a number of information bits, each bit for a UE in the DRX group. The value of that information bit unambiguously tells the UE whether there is data transmission allocated for the UE.

In another exemplary embodiment of the present invention, the DRX operation is performed by a UE. That is, upon starting of an ODT, a UE searches for an AI-RNTI message. Upon detecting an AI-RNTI message, the UE performs various activities depending on the value contained in the AI-RNTI message.

For example, if there is an AI-RNTI message and the value of a bit in the message corresponding to the UE is negative, the MS stops the ODT and the IAT and may switch to an “Off” state if the MS has no UL activity pending. Otherwise, the MS stays in an “On” state for receiving the data transmission. This exemplary embodiment also defines an Activity-Waiting Timer, which is started at this moment. The expiration of the Activity-Waiting Timer switches the MS to an “Off” state.

According to an exemplary implementation, the UE also monitors PDCCH for its own data transmission, besides monitoring AI-RNTI because the eNB may skip transmission of the AI message and send data to the UE directly.

According to another exemplary embodiment, an eNB broadcasts a list of DRX Start Offsets and explicitly assigns a specific DRX Start Offset to a UE. That is, the eNB assigns the UE to a specific DRX group when the eNB configures the DRX parameters. Similarly, the eNB could explicitly assign the UE the location of the DRX Start Offset using an information bit inside the AI message.

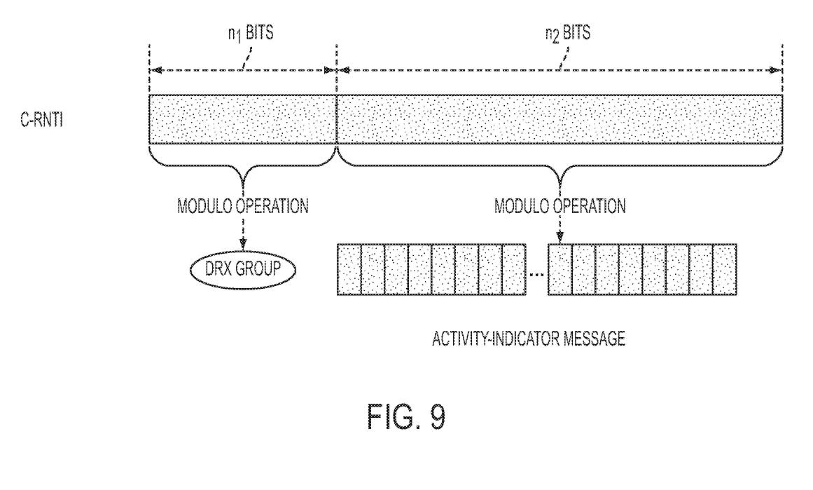

FIG. 9 illustrates an identifier message used to assign a UE to a DRX group according to an exemplary embodiment of the present invention.

In the exemplary embodiment, an eNB broadcasts a list of DRX Start Offsets but implicitly assigns a specific DRX group to an MS, and implicitly assigns the MS the location of its information bit in the AI message. In an exemplary implementation, this may be done as follows. Each UE is assigned a Cell-RNTI (C-RNTI) within the cell by the eNB during network entry by the UE. Referring to FIG. 9, the eNB may detect a C-RNTI in such a way that the first n₁ bits of the C-RNTI identify the specific DRX group, and the remaining n₂ bits of the C-RNTI identify the specific information bit inside the AI message.

For example, it is assumed that there are N DRX groups and that each AI message has K information bits. Both the eNB and the UE implicitly know the DRX group and the location of the information bit for the UE with a C-RNTI using Equation (5) and Equation (6).

DRX Group=(value of n₁ bits of C-RNTI) modulo N Eq. (5)

Index of AI message=(value of n₂ bits of C-RNTI) modulo K Eq. (6)

In an exemplary implementation, when generating a C-RNTI for a UE, the eNB may pick the first n₁ bits such that all the UEs will be equally distributed into the DRX groups. The eNB shall pick up the remaining n₂ bits such that there is no collision when the UEs within a DRX group refer to their information bits inside the AI message. To this end, the BS may reassign a proper C-RNTI to a UE if necessary.

According to the above described exemplary embodiments of the present invention, UEs are distributed into DRX groups so that they do not all wake up at the same time. This resolves a scheduling limitation the eNB suffers if data is to be transferred to a large number of UEs during the “On Duration”.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A Discontinuous Reception (DRX) control method of a base station in a wireless communication system, the method comprising:
executing a DRX mode;
assigning a plurality of DRX Start Offsets to a plurality of mobile stations served by the base station.

2. The method of claim 1, wherein the assigning of the plurality of DRX Start Offsets comprises assigning a one of the plurality of DRX Start Offsets to each of the plurality of mobile stations served by the base station to avoid excessive concurrent signaling by the base station.

3. The method of claim 1, further comprising:
dividing the plurality of mobile stations into two or more groups,
wherein the assigning of the plurality of DRX Start Offsets to the plurality of mobile stations comprises assigning a unique DRX Start Offset to each of the two or more groups.

4. The method of claim 3, wherein the number of mobile stations within each of the two or more groups is substantially the same.

5. The method of claim 3, wherein the unique DRX Start Offsets assigned to each of the two or more groups are spaced from each other by a substantially same amount of time.

6. The method of claim 3, further comprising:
transmitting a message to all mobile stations of a first group,
wherein the message comprises information for each mobile station of the first group regarding whether there is data to be transmitted to each mobile station.

7. The method of claim 6, wherein the transmitting of the message comprises at least one of broadcasting and multicasting the message.

8. The method of claim 6, wherein the message comprises an Activity-Indicator-Radio Network Temporary Identifier (AI-RNTI) message.

9. The method of claim 8, wherein the AI-RNTI message comprises a plurality of information bits, each information bit corresponding to a respective mobile station of the first group and indicating whether there is data to be transmitted to the respective mobile station.

10. The method of claim 6, wherein the transmitting of the message comprises transmitting the message at the beginning of an on duration of the first group.

11. The method of claim 1, wherein the assigning of the plurality of DRX Start Offsets to the plurality of mobile stations served by the base station comprises:
broadcasting a list of DRX Start Offsets; and
assigning each mobile station to one of the broadcast DRX Start Offsets.

12. The method of claim 11, wherein the assigning of each mobile station to one of the broadcast DRX Start Offsets comprises transmitting an Activity-Indicator-Radio Network Temporary Identifier (AI-RNTI) message including information regarding the assigned DRX Start Offset for each mobile station.

13. The method of claim 12, wherein the AI-RNTI message comprises a plurality of information bits, each information bit corresponding to a respective mobile station and indicating the assigned DRX Start Offsets for the respective mobile station.

14. The method of claim 1, further comprising:
generating a Cell-Radio Network Temporary Identifier (C-RNTI) for each of the plurality of mobile stations; and
assigning a corresponding C-RNTI to each of the plurality of mobile stations,
wherein the assigning of the plurality of DRX Start Offsets to the plurality of mobile stations comprises broadcasting a list of DRX Start Offsets and further wherein the C-RNTI assigned to each mobile station includes information regarding the assigned DRX Start Offset for each mobile station.

15. The method of claim 14, wherein the generating of a C-RNTI for each of the plurality of mobile stations comprises:
dividing the plurality of mobile stations into N groups; and
determining a DRX Group of a mobile station using the equation:
DRX Group=(value of first n₁ bits of C-RNTI) modulo N.

16. The method of claim 15, further comprising:
selecting the number of n₁ bits of C-RNTI such that the plurality of mobile stations will be distributed substantially equally.

17. The method of claim 16, further comprising:
transmitting an Activity-Indicator (AI) message comprising K information bits to all mobile stations included in one of the N groups; and
determining an index of the AI message for a mobile station using the equation:
AI message index=(value of remaining n₂ bits of C-RNTI) modulo K,
wherein the AI message index indicates a location within the AI message of an information bit associated with the mobile station.

18. The method of claim 17, wherein the information bit indicates whether there is data to be transmitted to the mobile station.

19. A Discontinuous Reception (DRX) control method of a mobile station in a wireless communication system, the method comprising:
entering a DRX mode;
starting an On Duration Timer;
determining if a message indicating activity for the mobile station is received;
if the message indicating activity for the mobile station is received, determining if the message indicates an activity;
if the message does not indicate an activity, transitioning to a sleep mode; and
if the message indicates an activity, receiving data transmission.

20. The method of claim 19, wherein the entering of the DRX mode comprises:
determining one of a long DRX mode and a short DRX mode;
when the short DRX mode is determined, the starting of the On Duration Timer at the beginning of a subframe satisfies the equation:
[(SFN*10)+subframe number] modulo (Short DRX Cycle)=(DRX Start Offset) modulo (Short DRX Cycle); and
when the long DRX mode is determined, the starting of the On Duration Timer at the beginning of a subframe satisfies the equation:
[(SFN*10)+subframe number] modulo (Long DRX Cycle)=DRX Start Offset.

21. The method of claim 19, further comprising, if the message does not indicate an activity:
stopping the On Duration Timer; and
stopping a DRX Inactivity Timer.

22. The method of claim 19, further comprising, if the message indicates an activity:
starting an Activity-Waiting timer; and
transitioning to a sleep mode at the expiration of the Activity-Waiting timer.

23. A Discontinuous Reception (DRX) control method of a mobile station in a wireless communication system, the method comprising:
receiving a Cell-Radio Network Temporary Identifier (C-RNTI) upon entering a network;
entering a DRX mode;
receiving a list of DRX Start Offsets; and
determining, using the C-RNTI, a DRX Start Offset from the list of DRX Start Offsets for use in the DRX mode.

24. The method of claim 23, wherein the determining of the DRX Start Offset comprises using the equation:
DRX Group=(value of first n₁ bits of C-RNTI) modulo N,
wherein N denotes a number of groups into which a plurality of mobile stations were divided and DRX Group denotes a DRX Start Offset associated with a group of mobile stations.

25. The method of claim 24, further comprising:
receiving an Activity-Indicator (AI) message comprising K information bits; and
determining an index of the AI message using the equation:
AI message index=(value of remaining n₂ bits of C-RNTI) modulo K,
wherein the AI message index indicates a location within the AI message of an information bit associated with the mobile station.
